(19) United States
(12) Patent Application Publication
(10) Pub. No.: US 2025/0271305 A1
(43) Pub. Date: Aug. 28, 2025

(54) DISPLAY LIGHT MEASURING APPARATUS, LIGHT MEASURING METHOD, AND RECORDING MEDIUM

(71) Applicant: Konica Minolta, Inc., Tokyo (JP)

(72) Inventor: Satoshi MASUDA, Osaka (JP)

(21) Appl. No.: 19/062,361

(22) Filed: Feb. 25, 2025

(30) Foreign Application Priority Data
Feb. 28, 2024 (JP) 2024-028918

(51) Int. Cl. G01J 3/50; G01J 3/02

(52) U.S. Cl. CPC G01J 3/505; G01J 3/0297

(57) ABSTRACT

A display light measuring apparatus includes: an optical sensor, an integration circuit that has an integration capacitor and accumulates electric charge output from the optical sensor; a light shielding member that shields incident light on the optical sensor; a calibrator that acquires a dark output value which is an output value of a quantity of incident light on the optical sensor in a state where the incident light on the optical sensor is shielded by the light shielding member, the calibrator performing zero calibration on the basis of the acquired dark output value; and a controller that sets a delay time for delaying the acquisition of the dark output value.

### CROSS-REFERENCE TO RELATED APPLICATION

The present invention claims priority under 35 U.S.C. § 119 to Japanese Patent Application No. 2024-028918 filed on Feb. 28, 2024, the entire content of which is incorporated herein by reference.

### BACKGROUND OF THE INVENTION

### 1. Technical Field

The present invention relates to a display light measuring apparatus and a measuring method for measuring the luminance, color, etc. of a display, and a recording medium.

### 2. Description of Related art

As the light measuring apparatus as described above, a display color analyzer (CA-410 manufactured by Konica Minolta, Inc. as an example) is known, for example. Such a display color analyzer includes an optical sensor equivalent to a spectral responsivity therein and acquires a stimulus value.

There are roughly two kinds of methods for acquiring a stimulus value, that is, a sequential acquisition method for acquiring an instantaneous value and an integral acquisition method for acquiring an integral value for a determined time. While the sequential acquisition method is excellent in high speed performance, an integration circuit is suitable and widely used as means for measuring a wide range of luminance from low luminance to high luminance with a high S/N ratio. In particular, in recent years, a technology for reducing a dark current and circuit noise has advanced, and thus, the integration circuit is becoming able to perform integration for a long time. A weaker photocurrent can be handled, and thus, further improvement in performance in a low luminance region is expected.

Japanese Unexamined Patent Application Publication No. 2005-321313 discloses a light detection device that includes an integration circuit as described above and has a wide dynamic range and an improved S/N ratio.

Further, International Publication No. 2018-198674 discloses a light detection device capable of measuring luminance in a wide range and with a high S/N ratio without increasing the cost.

As a method for suppressing a measurement error caused by a dark current of an optical sensor and an offset of a circuit, there is zero calibration.

The zero calibration is a process of preparing an output value (zero calibration value) in a state where an index value is to be set to a zero value and subtracting the zero calibration value from the output value (acquired with an optical path being opened) at the time of light measurement.

The zero calibration value is generated from a dark output value that is an output value acquired in a light-shielded state in which the optical path is closed with respect to the optical sensor. The dark output value is acquired under conditions that can generate a zero calibration value corresponding to photometric conditions (e.g., integration time and capacitance of an integration circuit (circuit gain)) used in light measurement.

For example, in a system having a plurality of circuit gains, zero calibration values respectively corresponding to the circuit gains are required, so that a plurality of dark output values is to be acquired as a condition. Basically, the dark output is acquired for each circuit gain, but if the dark output can be shared by a plurality of circuit gains, the number of times the dark output value is acquired can be reduced.

The integration time is also similar to the circuit gain and needs to be acquired under conditions that can generate a zero calibration value corresponding to photometric conditions at the time of light measurement. The same photometric conditions are not always necessary.

There are roughly two kinds of timings for acquiring the dark output value for the zero calibration. The first is a method for acquiring a dark output value for each light measurement (immediate type). The second is a method for acquiring and holding a dark output value in advance prior to the execution of measurement (prior type).

The zero calibration of an immediate type is performed continuously with light measurement immediately before or immediately after the light measurement. The zero calibration executed immediately after the light measurement provides an advantage that only one condition (only a condition same as that for the previous light measurement) is set for acquiring a dark output value, because the photometric condition used for the light measurement is known.

In the prior type zero calibration, the dark output value is generally acquired at, for example, the following timings (1) to (3), that is, (1) at the time of activation, (2) at a timing at which an output value of a temperature sensor exceeds an allowable range with reference to a value at the time of the previous zero calibration (this is performed for the purpose of reducing a drift error), and (3) at a timing at which a user's request is issued. Since photometric conditions at the time of light measurement are unknown, it is common to acquire all dark output values in advance for a plurality of main conditions.

A light measuring apparatus provided with an integration circuit needs a reset operation for changing the potential of an integration capacitor in the integration circuit to a reference potential before the execution of measurement.

In a case where the zero calibration is performed using a light measuring apparatus provided with an integration circuit in a state where a display to be measured is turned on, the integration operation is undesirably started in a state where the integration capacitor does not reach the reference potential (a state where an electric charge signal remains). When the zero calibration is performed in such a state, the acquired dark output value has an error corresponding to slightly remaining electric charges (residual electric charges). As a result, a slight error occurs when the measurement in a low luminance range is performed with the zero calibration value.

Conventionally, the measurement of a display has a limitation in low luminance performance that can be expressed, and thus, an error due to this slight residual electric charges is not problematic.

However, in recent years, the dynamic range of brightness that can be expressed by a display has been extended on both the high luminance side and the low luminance side. For this reason, there is a problem in which an error due to the slight residual electric charges generated when the zero calibration is performed in the high luminance region cannot be ignored.

### SUMMARY OF THE INVENTION

An object of the present invention is to provide a display light measuring apparatus and a measuring method that can suppress a reduction in accuracy of zero calibration due to residual electric charges of an integration capacitor of an integration circuit, and a recording medium.

A first aspect of the present invention relates to
a display light measuring apparatus including:
an optical sensor;
an integration circuit that has an integration capacitor and accumulates electric charge output from the optical sensor;
a light shielding member capable of shielding incident light on the optical sensor;
a calibrator that acquires a dark output value which is an output value of a quantity of incident light on the optical sensor in a state where the incident light on the optical sensor is shielded by the light shielding member, the calibrator performing zero calibration on the basis of the dark output value that has been acquired; and
a controller that sets a delay time for delaying the acquisition of the dark output value.

A second aspect of the present invention relates to
a display light measuring method performed by a display light measuring apparatus including
an optical sensor,
an integration circuit that has an integration capacitor and accumulates electric charge output from the optical sensor, and
a light shielding member capable of shielding incident light on the optical sensor, the method including:
acquiring a dark output value that is an output value of a quantity of incident light on the optical sensor in a state where the incident light on the optical sensor is shielded by the light shielding member;
performing zero calibration on the basis of the dark output value that has been acquired; and
setting a delay time for delaying the acquisition of the dark output value.

A third aspect of the present invention relates to
a non-transitory recording medium storing a computer readable program for causing a computer of a display light measuring apparatus including
an optical sensor,
an integration circuit that has an integration capacitor and accumulates electric charge output from the optical sensor, and
a light shielding member capable of shielding incident light on the optical sensor to execute:
acquiring a dark output value that is an output value of a quantity of incident light on the optical sensor in a state where the incident light on the optical sensor is shielded by the light shielding member;
performing zero calibration on the basis of the acquired dark output value; and
setting a delay time for delaying the acquisition of the dark output value.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a block diagram illustrating a configuration of a display light measuring apparatus according to an embodiment of the present invention;

FIG. 2 is a state transition diagram of the display light measuring apparatus according to the first embodiment;

FIG. 3 is a flowchart illustrating operation in a standby state of the display light measuring apparatus according to the first embodiment;

FIG. 4 is a flowchart illustrating operation when the display light measuring apparatus according to the first embodiment performs zero calibration;

FIG. 5 is a flowchart illustrating operation when the display light measuring apparatus according to the first embodiment executes measurement;

FIG. 6A to FIG. 6C each illustrate an example of a timing chart of the operation of the display light measuring apparatus according to the first embodiment;

FIG. 7 is a table illustrating a history of standby light quantity values in a second embodiment;

FIG. 8 is a lookup table for determining a requested delay time in the second embodiment;

FIG. 9 is a state transition diagram of a display light measuring apparatus according to a third embodiment;

FIG. 10 is an example of a timing chart of the operation of the display light measuring apparatus according to the third embodiment;

FIG. 11 is a flowchart illustrating operation when a display light measuring apparatus according to another embodiment performs zero calibration; and

FIG. 12 is an example of a timing chart of the operation of the display light measuring apparatus according to the other embodiment.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the accompanying drawings.

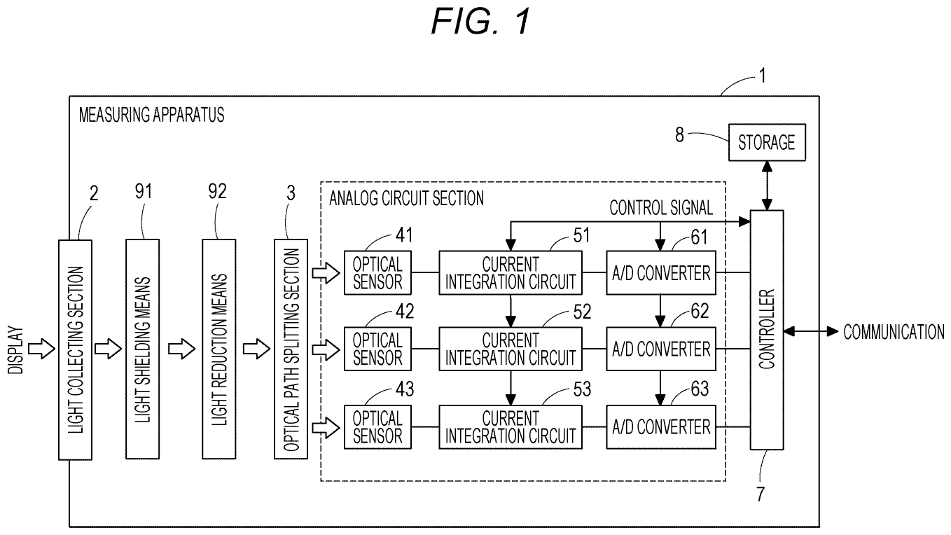

FIG. 1 is a block diagram illustrating the configuration of a display light measuring apparatus 1 according to an embodiment of the present invention.

The display light measuring apparatus 1 includes a light collecting section 2, a light shielding member 91, a light reduction member 92, an optical path splitting section 3, three optical sensors 41 to 43, three current integration circuits 51 to 53, three A/D converters 61 to 63, a controller 7, and a storage 8.

The light collecting section 2 includes a condenser lens or the like, and collects light emitted from a display which is an object to be measured.

The light shielding member 91 is a member that shields incident light on the optical sensors 41 to 43 at the time of zero calibration, and is provided so as to be able to open and close the optical path for incident light on the optical sensors 41 to 43. As the light shielding member 91, a shutter, for example, is used in the present embodiment.

The light reduction member 92 is a member that limits a quantity of light incident on the optical sensors 41 to 43 in order to extend a measurement luminance range, and is provided in such a manner as to be insertable into and removable from the optical path for the incident light on the optical sensors 41 to 43. As the light reduction member 92, an ND filter, for example, is used in this embodiment. Note that the light reduction member 92 may not be provided.

The optical path splitting section 3 splits the optical path of light collected by the light collecting section 2 into three.

The optical sensors 41 to 43 receive the light of the respective optical paths split into three by the optical path splitting section 3. The optical sensors 41 to 43 may be a tristimulus value direct reading type or a spectroscopic type.

The current integration circuits 51 to 53 accumulate electric charges output from the respective optical sensors 41 to 43 in integration capacitors, and output output values corresponding to the amounts of the accumulated electric charges. In the present embodiment, each of the current integration circuits 51 to 53 has a plurality of selectable gains. That is, the capacitance of the integration capacitor can be changed to a plurality of values.

The A/D converters 61 to 63 convert the output values of the current integration circuits 51 to 53 into digital signals.

The optical sensors 41 to 43, the current integration circuits 51 to 53, and part of the A/D converters 61 to 63 form an analog circuit section.

The controller 7 comprehensively controls the entire display light measuring apparatus 1. For example, the controller 7 calculates a stimulus value on the basis of the output signal values of the A/D converters 61 to 63, or communicates with an external device (not illustrated) such as a personal computer. The stimulus values to be calculated include, for example, tristimulus values represented by luminance, chromaticity (xy), and XYZ. Furthermore, in this embodiment, the controller 7 performs zero calibration. That is, the controller 7 also functions as a calibrator. The zero calibration is performed by the controller 7 acquiring dark output values, which are output values of the quantity of light entering the optical sensors 41 to 43, in a state where the light shielding member 91 shields light entering the optical sensors 41 to 43. Then, the controller 7 calibrates the measurement value on the basis of the acquired dark output values.

The controller 7 also functions as a monitor that monitors the output values of the quantity of light incident on the optical sensors 41 to 43 based on the output values of the respective current integration circuits 51 to 53 from before the execution of the zero calibration. In the following description, the output value of the quantity of incident light monitored from before the execution of the zero calibration is also referred to as a standby light quantity value, and the monitoring of the standby light quantity value is also referred to as light quantity monitoring.

Furthermore, the controller 7 compares the standby light quantity value obtained with the light quantity monitoring with a preset threshold, and sets a residue flag when the standby light quantity value is larger than the threshold. The residue flag is a flag indicating that residual electric charges that decrease the accuracy of zero calibration are present in the integration capacitors of the current integration circuits 51 to 53. In the zero calibration, the controller 7 sets a delay time for delaying the acquisition of the dark output value based on the standby light quantity value. These points will be described later.

The controller 7 also has a timer function. This timer function is used to autonomously (periodically) acquire the output value of the quantity of light incident on the optical sensors 41 to 43 even during the standby state. Furthermore, it is used for time management from the start of the zero calibration to the acquisition of the dark output value.

The controller 7 includes a computer including a hardware processor such as a CPU and a ROM.

The storage 8 accumulates and stores a history of monitored standby light quantity values for the optical sensors 41 to 43 with light quantity monitoring before the execution of zero calibration. The storage 8 further stores a lookup table for determining, based on the standby light quantity value, a time for eliminating the residual electric charges of the integration capacitors, that is, the above-described delay time. Furthermore, the storage 8 stores a program and other data.

### First Embodiment

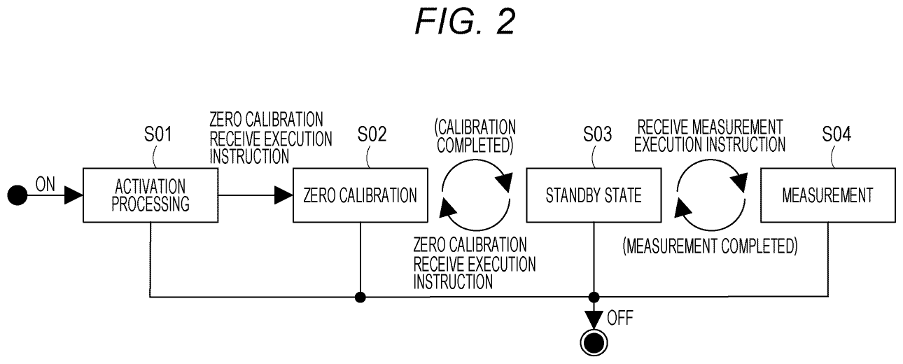

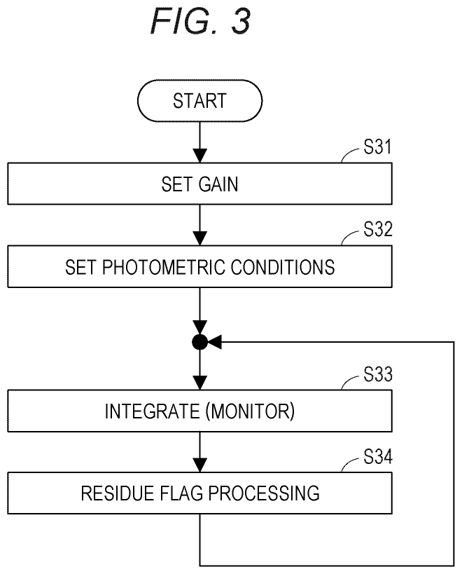

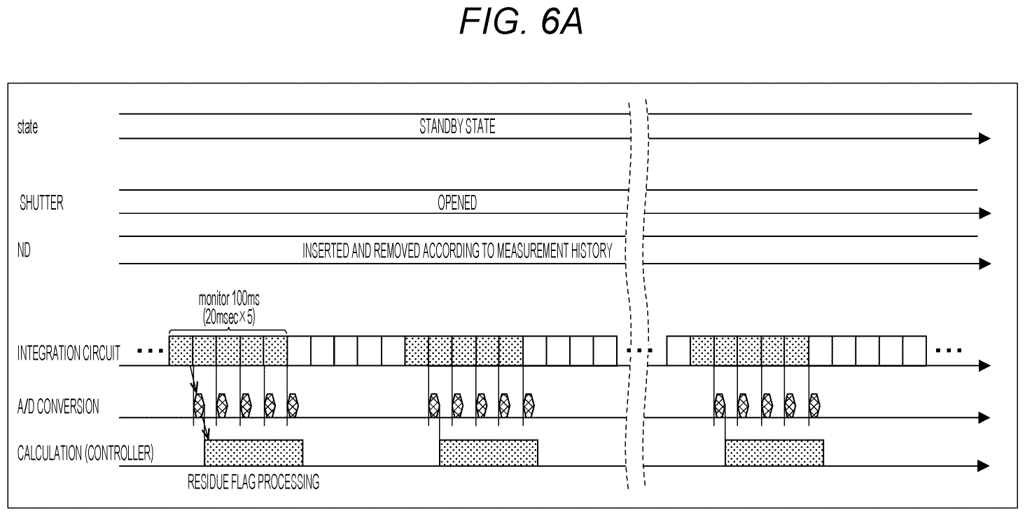

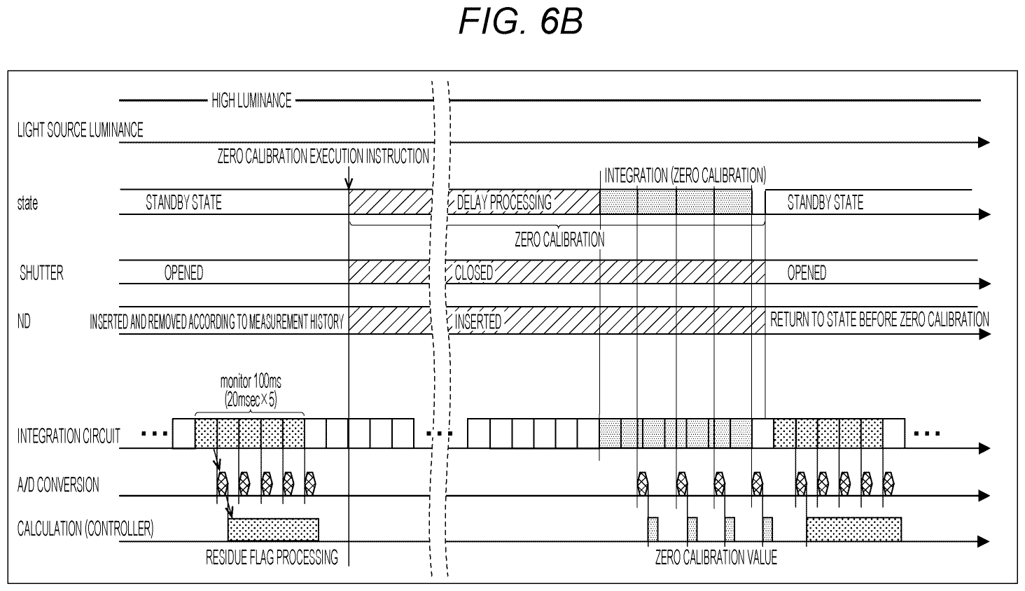

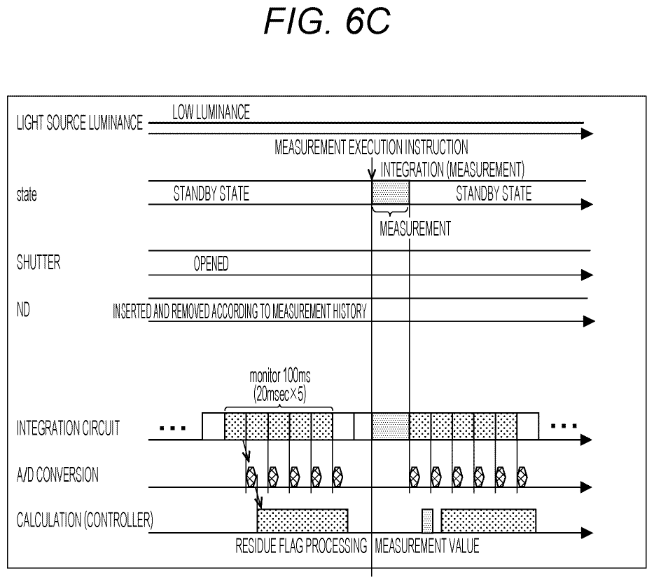

Next, the first embodiment of the display light measuring apparatus 1 will be described with reference to FIG. 2 that is a state transition diagram of the display light measuring apparatus 1, flowcharts in FIGS. 3 to FIG. 5, and examples of timing charts in FIGS. 6A to FIG. 6C.

The first embodiment is applied to a method (prior type) for acquiring and holding a dark output value for the zero calibration in advance before the execution of measurement. As described above, the dark output value is an output value acquired in a light-shielded state in which the optical path to the optical sensors 41 to 43 is closed.

In the state transition diagram of FIG. 2, when a power source is turned on, the display light measuring apparatus 1 performs activation processing in step S01. Upon receiving a zero calibration execution instruction, the display light measuring apparatus 1 performs the zero calibration in step S02.

After completing the zero calibration, the display light measuring apparatus 1 enters a standby state in step S03. When receiving the zero calibration execution instruction in the standby state, the display light measuring apparatus 1 returns to step S02 and performs the zero calibration.

When receiving a measurement execution instruction in the standby state, the display light measuring apparatus 1 performs measurement in step S04. After completing the measurement, the display light measuring apparatus 1 returns to step S03 and enters the standby state again. Thereafter, the display light measuring apparatus 1 repeats standby of step S03, the zero calibration of step SO2 as necessary, and the measurement of step S04. When a user turns off the power source, the display light measuring apparatus 1 transitions to a stopped state.

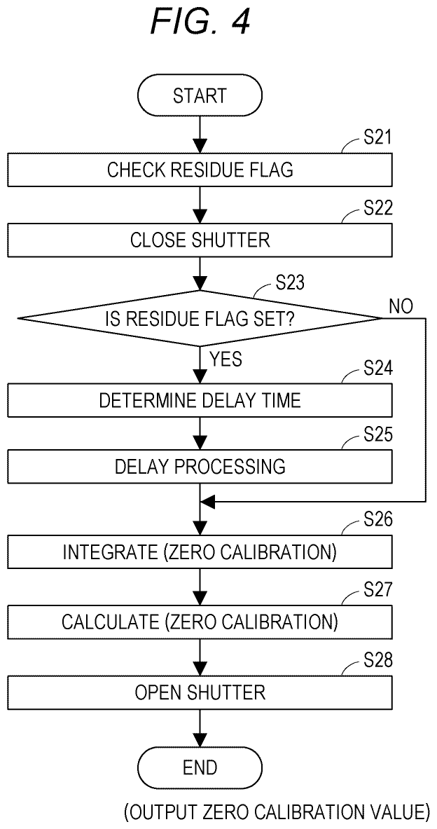

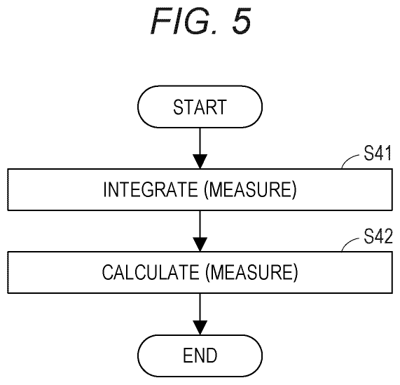

The flowchart of FIG. 3 illustrates the operation in the standby state, the flowchart of FIG. 4 illustrates the operation at the time of zero calibration, and the flowchart of FIG. 5 illustrates the operation at the time of execution of measurement. The operations illustrated in the flowcharts of FIG. 3 and subsequent drawings are executed by the processor of the controller 7 of the display light measuring apparatus 1 operating in accordance with an operation program.

FIG. 6A illustrates a timing chart in the standby state, FIG. 6B illustrates a timing chart at the time of zero calibration, and FIG. 6C illustrates a timing chart at the time of measurement.

### Activation Processing

The activation processing is the same as that of the conventional display light measuring apparatus, so that the description thereof will be omitted. The operation of the display light measuring apparatus 1 after the completion of the activation processing is the same as the operation in the standby state described later, and the light quantity monitoring is performed.

### Operation in Standby State

In step S31 in FIG. 3, the controller 7 sets the gain of each of the current integration circuits 51 to 53. In the standby state, the controller 7 monitors the quantity of light, but in order to avoid failure of the light quantity monitoring due to exposure with high luminance, the gains of the current integration circuits 51 to 53 are set to the minimum (the capacitance values of the integration capacitors are set to the maximum). If there is a margin in the calculation capability of the controller 7, the controller 7 may control the gains of the current integration circuits 51 to 53 in real time. By using variable gains, the accuracy of the light quantity monitoring can be improved.

Next, in step S32, the controller 7 sets photometric conditions (an exposure time, an integration time, the number of times of integration, and a monitoring cycle) in the light quantity monitoring. In the present embodiment, they are set as follows.
Integration time: 20 msec
Exposure time: 100 msec (the output of the current integration circuit is integrated five times)
Light quantity monitoring cycle: 200 msec

As the exposure time is set longer, the accuracy of the light quantity monitoring is improved, but the response to the quantity of exposure light deteriorates, and therefore, it is not suitable for the determination of the residual electric charge. On the other hand, when the exposure time is shortened too much, the response is improved, but only a part of the light emission waveform is picked up, resulting in a decrease in accuracy. In view of these, an appropriate range of the exposure time is 1/120 to 1/10 seconds. In the present embodiment, a time of 100 msec that is a substantially common multiple is selected so that synchronization can be achieved in both NTSC and PAL, which are general-purpose standards.

Note that if the cycle of a vertical synchronization signal (Vsync) of the display to be measured is known, the value of the known cycle may be acquired and determined. Examples of such a case include a case where the user has already set the frequency of the vertical synchronization signal. In order to improve the accuracy of the light quantity monitoring, the exposure time is preferably a multiple of a natural number of the cycle of the vertical synchronization signal.

The integration time is a time obtained by dividing the exposure time by a natural number (the number of divisions is the number of times of integration). In consideration of the S/N ratio of the photometric value, it is preferable to increase the integration time on the premise of conditions for avoiding saturation. In the present embodiment, 20 msec is selected, but it is not limited thereto.

In consideration of a response to the quantity of exposure light, it is appropriate to set the cycle of the light quantity monitoring to be shorter. However, if the cycle is shortened, a load is applied to the controller 7. In view of this, 200 msec is selected in this embodiment. In a case where there is a margin in the calculation capability of the controller 7, moving average processing is performed on the integrated output value obtained by separate exposure (for example, the average value of the latest five pieces of data is set as the output value of the quantity of light). Thus, the cycle of the light quantity monitoring can be shorter than the exposure time.

In step S33 in FIG. 3, the controller 7 performs photometry (integration) under the conditions determined in step S32. The controller 7 repeatedly performs the following procedures (1) to (3) until receiving a measurement execution instruction, and measures light.
(1) As indicated in the item of “integration circuit” in the timing chart in FIG. 6A, the controller 7 starts integration after resetting each of the current integration circuits 51 to 53. The controller 7 performs integration five times in a predetermined time (20 msec).
(2) As indicated in the item of “A/D conversion” in the timing chart in FIG. 6A, the controller 7 samples and holds the values output from the current integration circuits 51 to 53 when a predetermined time (20 msec) has elapsed.
(3) After the completion, the controller 7 returns to (1) and converts the values held in (2) into digital data by the A/D converters 61 to 63 in the subsequent stage.

In the present embodiment, the current integration circuits 51 to 53 are operated even in a period in which the light quantity monitoring is not performed in the standby state. Since the integration capacitances are reset by the operation of the current integration circuits 51 to 53, the current integration circuits 51 to 53 are prevented from becoming oversaturated. This is to prevent the current integration circuits 51 to 53 which are in an oversaturated state from taking time to return to an appropriate state. Note that the A/D conversion by each of the A/D converters 61 to 63 is performed by extracting only data corresponding to the light quantity monitoring for the purpose of reducing a load on the controller 7.

In step S34 in FIG. 3, the controller 7 performs residue flag processing (see the item of “calculation (controller)” in the timing chart in FIG. 6A). Specifically, the controller 7 first converts the data acquired in step S33 into a standby light quantity value. In a case where the exposure is separately performed a plurality of times as in the present embodiment, conversion processing is performed on a value obtained by averaging data for each exposure. The conversion processing includes dark output correction, circuit gain calibration, integration time normalization, and the like.

Next, the controller 7 determines, by comparison with a threshold, whether or not the obtained standby light quantity value has an intensity at a level at which the accuracy of zero calibration decreases. When the standby light quantity value exceeds the threshold, the controller 7 sets a residue flag indicating that electric charges remain in the integration capacitors of the current integration circuits 51 to 53. This process is performed every time the photometry in step S33 is performed, and the residue flag is updated. Note that in the present embodiment, the residue flag is set when the standby light quantity value of any of the three optical sensors 41 to 43 for XYZ exceeds the threshold, but the present invention is not limited thereto. For example, it may be determined whether or not the standby light quantity value for only a specific optical sensor exceeds the threshold.

### Operation at the Time of Zero Calibration

Upon receiving the instruction to execute zero calibration, the controller 7 checks, in step S21 in FIG. 4, whether or not residue flag information is blank. The reason for this is that not a single standby light quantity value with light quantity monitoring may be able to be acquired when, for example, zero calibration is executed immediately after activation. In a case where the residue flag information is blank, the light quantity monitoring is performed once.

Next, in step S22, the controller 7 closes the light shielding member (shutter) 91 to close the optical paths to the optical sensors 41 to 43 in order to acquire a dark output value. In the present embodiment, in order to reduce an error caused by leakage light, the light reduction member 92 is also forcibly inserted into the optical path. However, the light reduction member 92 may not be inserted into the optical path.

Next, in step S23, the controller 7 determines the presence or absence of a residue flag, that is, whether or not the residue flag is set. If the residue flag is set (YES in step S23), the controller 7 proceeds to step S24 and determines a delay time. The delay time is a time for delaying the start of acquisition of the dark output value for zero calibration in order to eliminate residual electric charges in the integration capacitors. In the present embodiment, a fixed value of 2.16 seconds is adopted as the delay time in order to ensure the required accuracy at low luminance.

Next, the controller 7 performs delay processing in step S25. That is, the controller 7 sets the delay time and waits for the operation of acquiring the dark output value for the delay time. After the delay time has elapsed, the processing proceeds to step S26. In the present embodiment, the integration operation of the current integration circuits 51 to 53 and the electric charge removal by resetting are performed also within the delay time for the purpose of reducing the remaining electric charges in the integration capacitors (see the timing chart in FIG. 6B). Note that the integration time in the integration operation within the delay time may be changed. For example, when the integration time is shortened, the number of times of resetting the current integration circuits 51 to 53 can be increased. In addition, if extreme control is possible, only the reset operation may be performed by continuously sending a reset instruction.

Note that, in a case where the residue flag is not set in step S23 (NO in step S23), there is no influence of residual electric charges on a decrease in accuracy of the zero calibration, and thus, the processing proceeds directly to step S26.

In step S26, the controller 7 acquires dark output values under a plurality of predetermined photometric conditions. In the present embodiment, as indicated in the timing chart of FIG. 6B, the controller 7 acquires the dark output value four times while switching the gains of the current integration circuits 51 to 53 under the condition that the exposure time is 1/30 [sec] (the integration is performed once).

In step S27, the controller 7 performs calculation processing, if necessary, on the dark output value acquired in step S26, and generates a zero calibration value. Examples of the calculation processing include normalization by integration time. The generated zero calibration value is stored in the storage 8 or the like.

In step S28, the controller 7 opens the light shielding member 91 in preparation for measurement, to thereby open the optical paths to the optical sensors 41 to 43.

### Operation at the Time of Execution of Measurement

When receiving the measurement execution instruction, the controller 7 stops the light quantity monitoring (discards the data if it is during the light quantity monitoring), and executes the measurement according to the normal procedure in step S41 in FIG. 5. Prior to the measurement, the controller 7 switches the gains of the current integration circuits 51 to 53 and derives photometric conditions as necessary, and then performs integration (measurement).

In the present embodiment, it is assumed that a display having a Vsync frequency of 60 Hz is measured, and the exposure time is set to 1/30 [sec] (the integration is performed once).

In step S42, the controller 7 converts the output value acquired by the measurement in step S41 into a measurement index value (e.g., a luminance value or a chromaticity value). Specifically, the controller 7 performs zero calibration processing on the output value to calibrate an offset error, and subsequently, performs normal processing of converting and calculating the output value to generate a target index value. After the calculation is completed, the display light measuring apparatus 1 transitions to a standby state (step S03 in FIG. 2).

As described above, in the first embodiment, a delay time is set before the start of the acquisition of the dark output value in response to the instruction to perform the zero calibration, and the start of the acquisition of the dark output value is delayed. Therefore, the residual electric charges remaining in the integration capacitors of the current integration circuits 51 to 53 are eliminated within the delay time. Therefore, a decrease in the accuracy of the zero calibration due to the residual electric charge can be suppressed by a simple method.

### Second Embodiment

The second embodiment is also applied to a method (prior type) for acquiring and holding a dark output value for the zero calibration in advance before the execution of measurement.

In the first embodiment, a fixed value is adopted as the delay time.

In contrast, in the second embodiment, the delay time is adjusted according to the standby light quantity value.

### Operation in Standby State

The operation of the display light measuring apparatus 1 in the standby state is the same as the operation example in the first embodiment illustrated in FIG. 3 except for the residue flag processing in step S34. Therefore, it is described with reference to the flowchart in FIG. 3.

In the residue flag processing of step S34, the controller 7 converts the data acquired in step S33 into a standby light quantity value. In the case where the exposure is separately performed a plurality of times as in the second embodiment, conversion processing is performed on a value obtained by averaging a plurality of pieces of data obtained in each exposure. The operation so far is the same as that of the first embodiment.

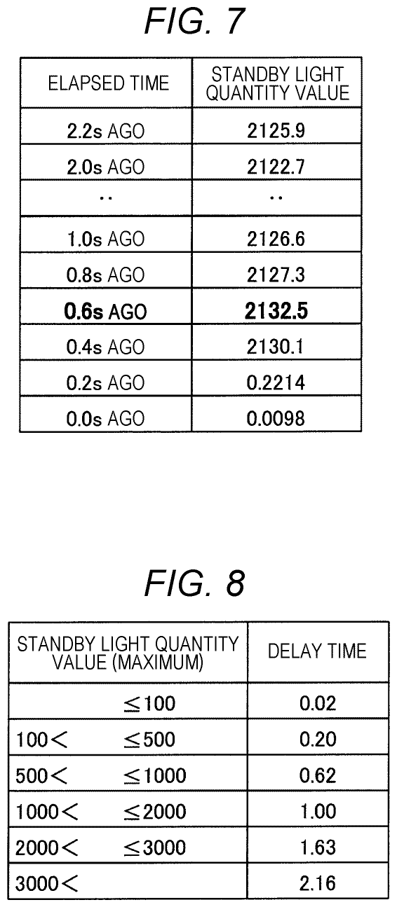

The controller 7 determines whether or not the standby light quantity value has an intensity at a level at which the accuracy of zero calibration decreases using also the standby light quantity value in the past. Specifically, the controller 7 holds, while updating, a history of standby light quantity values from the latest to a predetermined period in the past in the storage 8 every time a standby light quantity value by each exposure is acquired. The history of the standby light quantity values held in the storage 8 is illustrated in FIG. 7.

In the example of FIG. 7, the standby light quantity value is acquired and held every 0.2 seconds. Further, in the present embodiment, 2132.5, which is the maximum standby light quantity value among the outputs of the optical sensors 41 to 43 for XYZ, is adopted as the standby light quantity value serving as the basis of the calculation for the delay processing. However, the present invention is not limited thereto, and a standby light quantity value serving as a basis for calculation of the delay processing may be adopted based on, for example, a standby light quantity value for only a specific optical sensor. In addition, the history holding period for holding the history in the present embodiment is set to 2.2 seconds on the basis of a time required to eliminate residual electric charges in the case of a transition from the measurement maximum luminance to the measurement minimum luminance.

Further, the controller 7 determines whether or not the standby light quantity value exceeds a threshold every time the standby light quantity value is acquired, and sets a residue flag indicating that electric charges remain in the integration capacitors of the current integration circuits 51 to 53 in a case where there is a quantity of light exceeding the threshold within the history holding period. Here, the threshold is a minimum standby light quantity value at which a delay time occurs in a lookup table (LUT) for determining the delay time to be described later.

### Operation at the Time of Zero Calibration

The operation at the time of zero calibration is the same as that in the first embodiment except for the content of processing of determining the delay time in step S24 in FIG. 4. Therefore, it is described with reference to the flowchart of FIG. 4.

When receiving the instruction to execute the zero calibration, the controller 7 stops the light quantity monitoring (discards the data if it is during the light quantity monitoring). The controller 7 checks the residue flag information in step S21, closes the shutter in step S22, and then determines the presence or absence of the residue flag, that is, whether or not the residue flag is set in step S23. If the residue flag is set (YES in step S21), the processing proceeds to step S22.

In step S22, the controller 7 determines the delay time. First, the controller 7 determines a requested delay time based on the result of the above-described residue flag processing. In the present second embodiment, the controller 7 determines the requested delay time from the LUT in FIG. 8. As can be seen from the LUT in FIG. 8, the maximum delay time that can be set is 2.16 seconds. Therefore, the history holding time for holding the history of the standby light quantity values illustrated in FIG. 7 is set to 2.20 seconds.

In the LUT in FIG. 8, a requested delay time when a maximum value among the standby light quantity values held as a history is set as an input parameter is set. As described above, since the maximum value of 2132.5 in the history of the standby light quantity values indicated in FIG. 7 is adopted as the standby light quantity value serving as the basis of the calculation for the delay processing, the requested delay time is determined to be 1.63 seconds from the LUT in FIG. 8. In the LUT in FIG. 8, a longer delay time is set for a larger standby light quantity value. The reason is that a longer time is required for eliminating the residual electric charge as the standby light quantity value is larger. Note that the method for determining the requested delay time is not limited thereto. For example, an amount of change of the light quantity or the shape of the history may be added to the input parameter, or the requested delay time may be determined only on the basis of the latest value without accumulating the history of the standby light quantity values. Further, the requested delay time may be derived from a calculation formula.

Upon determining the requested delay time, the controller 7 derives, in accordance with the following expression, a delay time to actually wait until the start of measurement. Here, as the elapsed time in the following expression, the time of 0.6 seconds (see FIG. 7) for the standby light quantity value (2132.5) used for deriving the requested delay time is used. The determination of the elapsed time is not limited thereto.

Delay time=requested delay time−elapsed time=1.63 seconds−0.60 seconds=1.03 seconds

Thereafter, in step S23 in FIG. 4, the controller 7 sets the determined delay time and waits for the start of the operation of acquiring a dark output value. When the delay time elapses, the processes of step S24 and step S25 are performed. The processes of step S24 and step S25 are the same as those in the first embodiment.

### Operation at the Time of Execution of Measurement

This operation is the same as the operation in the first embodiment.

According to the second embodiment, a plurality of monitored standby light quantity values for each exposure is accumulated for the fixed time, the requested delay time is determined based on the accumulated standby light quantity values, and the delay time is determined. Therefore, an appropriate delay time is determined in accordance with the quantity of light at the time of exposure, that is, the residual electric charges in the integration capacitor. As a result, it is possible to avoid a disadvantage that an unnecessarily long delay time is set in spite of a small quantity of exposure light (residual electric charge in the integration capacitor) to cause waste of time.

### Third Embodiment

The third embodiment is applied to a method (immediate type) for acquiring, for each light measurement, a dark output value continuously with the light measurement under the same photometric conditions as those of the light measurement.

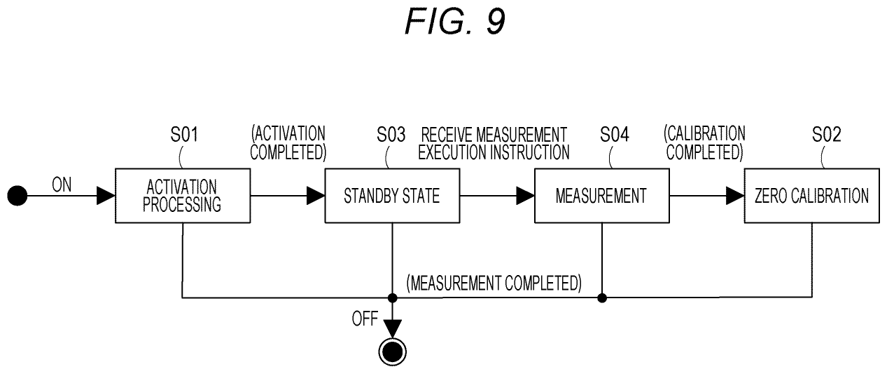

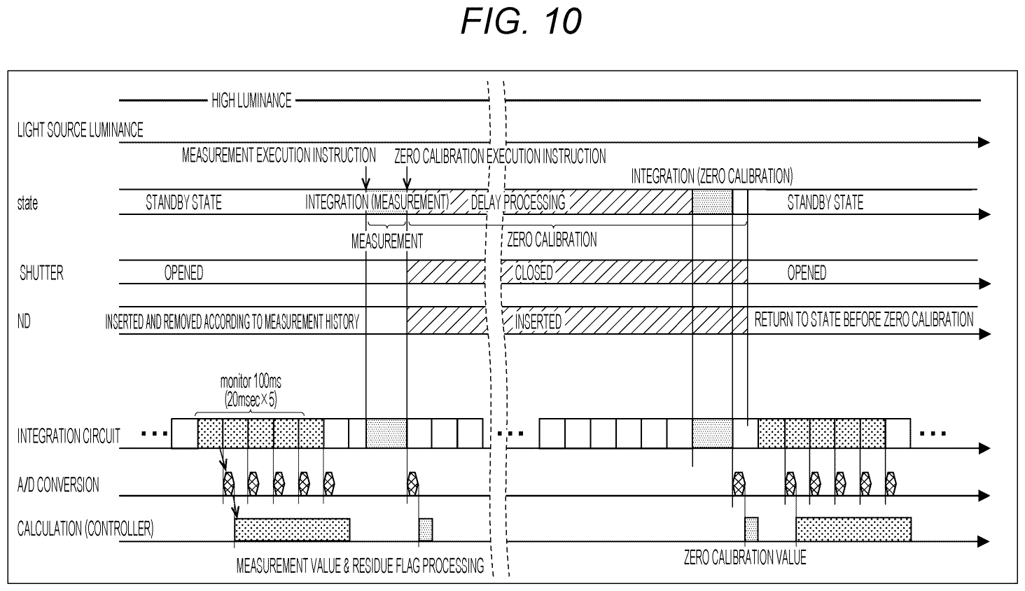

FIG. 9 is a state transition diagram of a display light measuring apparatus 1 according to the third embodiment. In the third embodiment, zero calibration is performed immediately after the measurement is performed in step S04. The zero calibration in step S02 may be performed immediately before the measurement in step S04. FIG. 10 illustrates an example of a timing chart according to the third embodiment.

### Operation in Standby State

The operation of the display light measuring apparatus 1 in the standby state is the same as that of the second embodiment except for the following points.

That is, the controller 7 acquires a standby light quantity value every fixed time. The controller 7 holds, while updating, a history of standby light quantity values from the latest to a predetermined period in the past in the storage 8. Note that, in the third embodiment, the light quantity value acquired in the measurement performed immediately before the instruction to execute the zero calibration is also included in the same history as the standby light quantity values and is used to determine the requested delay time.

### Operation at the Time of Zero Calibration

The operation of the display light measuring apparatus 1 at the time of zero calibration is the same as that of the second embodiment except for the following points.

That is, in the processing of determining a delay time in step S24 in FIG. 4, the delay time is determined in a state where the light quantity value acquired in the measurement performed immediately before the instruction to execute the zero calibration is also included in the same history as the standby light quantity values.

Since the third embodiment is a method applied to the immediate type, the controller 7 acquires the dark output value only once under the same conditions as those in the immediately preceding light measurement in the integration processing in step S26. Therefore, a zero calibration value for one dark output value is generated also in the calculation processing of step S27.

### Operation at the Time of Execution of Measurement

This operation is the same as the operation in the first embodiment.

In the third embodiment, a plurality of monitored standby light quantity values is accumulated for a predetermined time, and the delay time is determined based on the accumulated standby light quantity values and the photometric value in the immediately preceding light measurement. Therefore, the delay time can be finely adjusted, and it is possible to avoid a disadvantage that an unnecessarily long delay time is set in spite of a small quantity of exposure light (residual electric charge in the integration capacitor) to cause waste of time.

### Other Embodiments

While the embodiments according to the present invention have been described above, the present invention is not limited to the above-described embodiments.

For example, when the instruction to execute the zero calibration is received, the light shielding member 91 and/or the light reduction member 92 may be already present in the optical path to the optical sensors 41 to 43. In this case, the incident light is shielded or reduced, so that the quantity of light reaching the optical sensors 41 to 43 becomes extremely small, and thus, the residual electric charges in the current integration circuits 51 to 53 do not matter. Therefore, the delay time may not be set without performing steps S21 to S25 in FIG. 4.

Furthermore, although the light quantity monitoring is performed using at least one of the three optical sensors 41 to 43 for measurement, a dedicated optical sensor may be provided for the light quantity monitoring.

In addition, the user may be able to select whether to enable the setting of the delay time. For example, the setting of the delay time may be enabled only when high-accuracy measurement is needed. In this case, the measurement without having a delay time is performed as usual when the requirement for the accuracy is low, whereby the wasteful time until the start of the measurement is eliminated.

In the third embodiment, the dark output value for zero calibration is acquired immediately after the light measurement. However, the dark output value may be acquired immediately before the light measurement. In this case, when the measurement condition of the light measurement is known, the dark output value is acquired under the same condition as the measurement condition. If the measurement condition for the light measurement is unknown, dark output values may be acquired under a plurality of conditions as in the first embodiment.

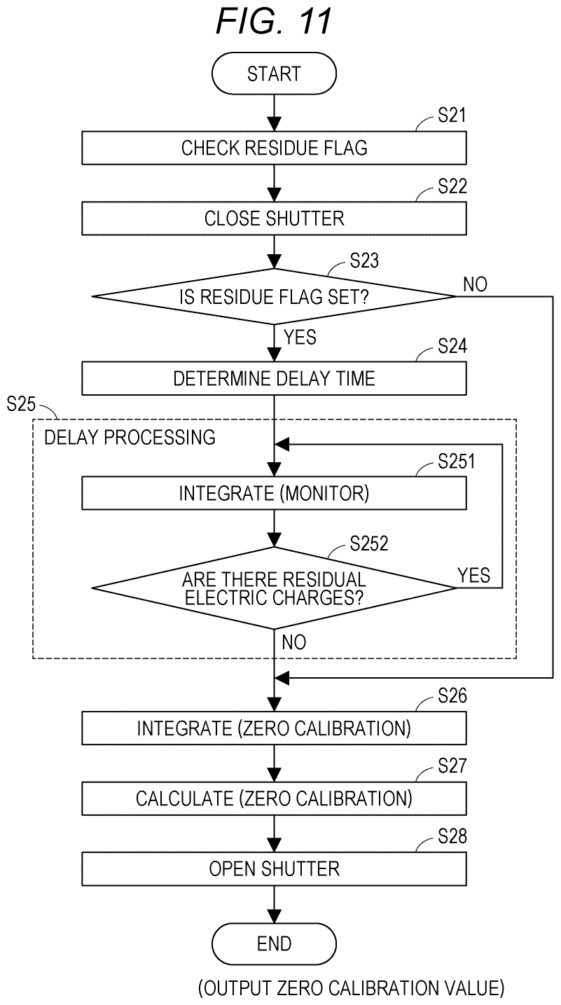

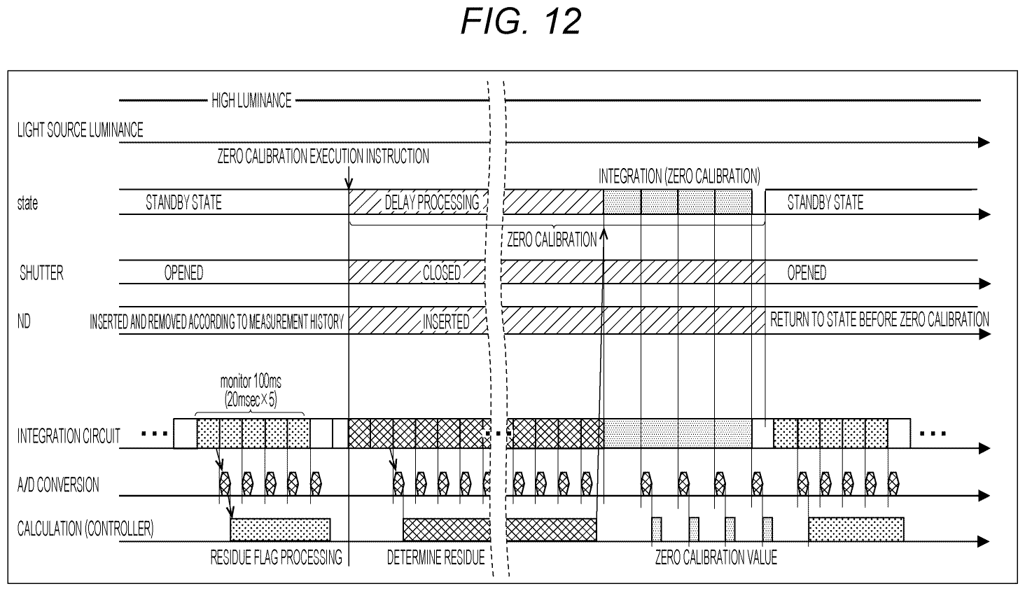

Further, as still another embodiment, the controller 7 may directly measure a light quantity output value by executing the light quantity monitoring process even during the delay time and determine the delay time based on the measured light quantity output value. This processing is indicated in the flowchart of FIG. 11 and the timing chart of FIG. 12.

As indicated by delay processing in step S25 in FIG. 11, the controller 7 monitors a light quantity value during the delay time determined in step S24 under the conditions that, for example, the exposure time is 20 msec and integration is performed once in step S251. The controller 7 determines in step S252 whether or not residual electric charges remain in the current integration circuits 51 to 53 on the basis of whether or not the standby light quantity value is within an allowable range. If there are residual electric charges in the current integration circuits 51 to 53 (YES in step S252), the monitoring of the light quantity value in step S251 and the determination of whether or not there are residual electric charges in step S252 are repeated until the residual electric charges disappear. When there is no residual electric charge (NO in step S252), the delay processing ends. The processes other than the delay processing of step S25 indicated in the flowchart of FIG. 11 are the same as those indicated in the flowchart of FIG. 4.

Further, as still another embodiment, the controller 7 may execute the light quantity monitoring processing once at the beginning of the delay time and determine the delay time again from the value obtained by the processing.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A display light measuring apparatus comprising:
an optical sensor;
an integration circuit that has an integration capacitor and accumulates electric charge output from the optical sensor;
a light shielding member capable of shielding incident light on the optical sensor;
a calibrator that acquires a dark output value which is an output value of a quantity of incident light on the optical sensor in a state where the incident light on the optical sensor is shielded by the light shielding member, the calibrator performing zero calibration on the basis of the dark output value that has been acquired; and
a controller that sets a delay time for delaying the acquisition of the dark output value.

2. The display light measuring apparatus according to claim 1, further comprising a monitor that monitors the output value of the quantity of incident light on the optical sensor from before execution of the zero calibration by the calibrator, wherein
the controller sets the delay time when the output value of the quantity of incident light monitored by the monitor exceeds a threshold.

3. The display light measuring apparatus according to claim 1, wherein the controller adjusts the delay time on the basis of the output value of the quantity of incident light monitored by the monitor.

4. The display light measuring apparatus according to claim 1, wherein, in a case where incident light on the optical sensor has already been shielded by the light shielding member at the time of reception of an instruction to execute the zero calibration by the calibrator, the controller does not set the delay time.

5. The display light measuring apparatus according to claim 1, further comprising a light reduction member, wherein,
in a case where incident light on the optical sensor has already been reduced by the light reduction member at the time of reception of an instruction to execute the zero calibration by the calibrator, the controller does not set the delay time.

6. The display light measuring apparatus according to claim 1, wherein the output value of the quantity of incident light monitored by the monitor is stored for a fixed period.

7. The display light measuring apparatus according to claim 1, wherein a capacitance of the integration capacitor is maximized except for a period in which measurement is executed in response to a measurement execution instruction.

8. The display light measuring apparatus according to claim 2, wherein the output value of the quantity of incident light is monitored by the monitor with an exposure time of the optical sensor being set in a range of 1/120 to 1/10 seconds.

9. The display light measuring apparatus according to claim 1, wherein whether to set the delay time is selectable by a user.

10. A display light measuring method performed by a display light measuring apparatus including
an optical sensor,
an integration circuit that has an integration capacitor and accumulates electric charge output from the optical sensor, and
a light shielding member capable of shielding incident light on the optical sensor, the method comprising:
acquiring a dark output value that is an output value of a quantity of incident light on the optical sensor in a state where the incident light on the optical sensor is shielded by the light shielding member;
performing zero calibration on the basis of the dark output value that has been acquired; and
setting a delay time for delaying the acquisition of the dark output value.

11. The display light measuring method according to claim 10, wherein the output value of the quantity of incident light on the optical sensor is monitored from before execution of the zero calibration, and when the output value of the quantity of incident light that has been monitored exceeds a threshold, the delay time is set.

12. The display light measuring method according to claim 10, wherein the delay time is adjusted based on the monitored output value of the quantity of incident light.

13. A non-transitory recording medium storing a computer readable program for causing a computer of a display light measuring apparatus including
an optical sensor,
an integration circuit that has an integration capacitor and accumulates electric charge output from the optical sensor, and
a light shielding member capable of shielding incident light on the optical sensor to execute:
acquiring a dark output value that is an output value of a quantity of incident light on the optical sensor in a state where the incident light on the optical sensor is shielded by the light shielding member;
performing zero calibration on the basis of the acquired dark output value; and
setting a delay time for delaying the acquisition of the dark output value.

14. The non-transitory recording medium according to claim 13, wherein the program causes the computer to execute processing of monitoring the output value of the quantity of incident light on the optical sensor before execution of the zero calibration and setting the delay time when the output value of the quantity of incident light that has been monitored exceeds a threshold.

15. The non-transitory recording medium according to claim 13, wherein the program causes the computer to perform processing of adjusting the delay time based on the output value of the quantity of incident light that has been monitored.
